(19) United States
(12) Patent Application Publication
(10) Pub. No.: US 2025/0254164 A1
(43) Pub. Date: Aug. 7, 2025

(54) MANAGING ACCESS TO SECURE ENTERPRISE RESOURCES USING IDENTITY VERIFICATION SERVICES AND VERIFIED AUTHENTICATORS

(71) Applicant: Entrust Corporation, Shakopee, MN (US)

(72) Inventor: IAN REILLY, Ottawa (CA)

(21) Appl. No.: 19/044,258

(22) Filed: Feb. 3, 2025

Related U.S. Application Data
(60) Provisional application No. 63/549,832, filed on Feb. 5, 2024.

(51) Int. Cl. H04L 9/40

(52) U.S. Cl. CPC H04L 63/0876; H04L 63/102; H04L 63/105

(57) ABSTRACT

Systems and methods for managing access to secure enterprise resources using identity verification services and verified authenticators are provided. In example aspects, users are required to perform identity verification before the user can register verified authenticators. In an example, an issued user card is used to verify the identity of the user. In further example aspects, enterprise resources may be associated with assurance levels defining the level of authentication required to access the enterprise resources. In an example, an enterprise resource may have an assurance level that requires multi-factor authentication with a verified authenticator to access the enterprise resource.

### CROSS-REFERENCE TO RELATED APPLICATIONS

This application claims priority to U.S. Provisional Patent Application No. 63/549,832 filed Feb. 5, 2024, the disclosure of which is incorporated herein by reference in its entirety.

### BACKGROUND

Enterprise applications allow users to access secure information and accounts, such as confidential information and financial accounts. To ensure secure access to these applications, multi-factor authentication is often required. This may require use of a registered authenticator on a user's mobile device, or the like. However, malicious actors may still gain access to the enterprise applications. Often, the only requirement to register an authenticator is user credentials, such as a username and password. If a malicious actor gains access to a user's credentials, the malicious actor can use the credentials to register an authenticator. Thus, by gaining access to the user's credentials, the malicious actor can access secure applications that require multi-factor authentication by using the maliciously-registered authenticator to provide that second factor authentication.

### SUMMARY

In accordance with aspects of the present disclosure, systems and methods for managing access to secure enterprise resources using identity verification services and verified authenticators are provided. In example aspects, identity verification is required to register a verified authenticator with an identity service. Access to applications may be limited to users that are authenticated using multi-factor authentication with verified authenticators.

In a first aspect, a method for managing access to enterprise resources is provided. A request to access an enterprise resource is received from a user. An assurance level of the enterprise resource is determined. Based on the assurance level of the enterprise resource, it is determined whether the user has an approved authenticator to access the enterprise resource and therefore is authenticated using the approved authenticator, or whether the user does not have the approved authenticator to access the enterprise resource and therefore would be denied access.

In a second aspect, a system for managing access to applications is provided. The system comprises one or more processors and one or more computer-readable storage devices storing data instructions. Executing the data instructions with one or more processors causes the system to receive a request from a user to access an application, determine an assurance level of the application, and determine whether the user has an approved authenticator to access the application. If the user has the approved authenticator to access the application, the system authenticates the user using the approved authenticator. If the user does not have the approved authenticator to access the application, the system denies the user access to the application. Whether the user has the approved authenticator is based on the assurance level of the application.

In a third aspect, a method for managing user security settings is provided. A request to modify security settings is received from a user. The user is authenticated using identity verification. The method includes, based on whether the user is authenticated, determining whether to enable user modification of the security settings or denying the user access to the security settings.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example system for managing access to applications.

FIG. 2 illustrates an example system for issuing identification documents.

FIG. 3 illustrates a flowchart of an example method for issuing identification documents.

FIG. 4 illustrates a flowchart of an example method for registering authenticators.

FIG. 5 illustrates an example message flow diagram for registering authenticators.

FIG. 6 illustrates an example message flow diagram for managing access to user security settings.

FIG. 7 illustrates a flowchart of an example method for authenticating users with identity verification.

FIG. 8 illustrates a flowchart of an example method for managing access to applications.

FIG. 9 illustrates an example message flow diagram for managing access to applications.

FIG. 10 illustrates example user records and application records.

FIG. 11 illustrates additional example user records and application records.

FIG. 12 illustrates an example computing device on which aspects of the present disclosure can be performed.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In accordance with aspects of the present disclosure, systems and methods for managing access to applications using verified authenticators are provided. In example aspects, users register verified authenticators with an identity service. For an authenticator to be verified, a user must perform identity verification during the registration process to authenticate the user.

In further aspects, applications are associated with assurance levels defining a level of authentication needed to access the applications. For example, applications that allow access to more secure information may have a higher assurance level than applications that allow access to less secure information. Applications with higher assurance levels may require more secure verification than applications with lower assurance levels. In an example, some applications may require users to perform multi-factor authentication with verified authenticators, while other applications may not require multi-factor authentication at all.

Requiring identity verification during the registration of verified authenticators and limiting access to secure applications to users that are authenticated with verified authenticators increases the security of the secure applications. Even if a malicious actor gains access to a user's account, the malicious actor cannot register a verified authenticator as the malicious actor will fail the identity verification. Accordingly, the malicious actor cannot access secure applications that require multi-factor authentication with verified authenticators.

In further embodiments, such higher level access involving identity verification may be applied in other contexts. For example, identity verification may be required for a user to access or edit profile information of that user, or to register a new authenticator.

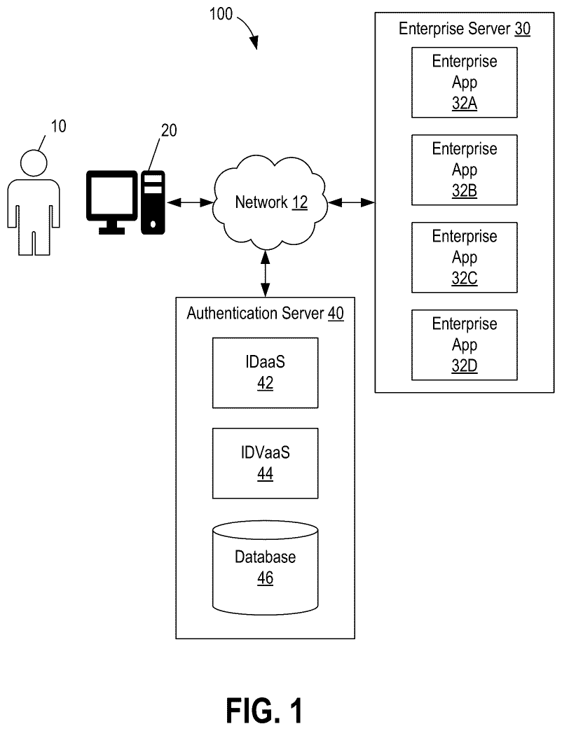

Turning now to FIG. 1, an example application access management system 100 is shown. In the illustrated embodiment, the system 100 includes a computing device 20, an enterprise server 30 and an authentication server 40. Although only one computing device 20 is shown, in alternative examples, multiple computing devices 20 may connect to the enterprise server 30 and the authentication server 40. Similarly, while the enterprise server 30 and the authentication server 40 are shown as individual servers, one or both of the enterprise server 30 and the authentication server 40 may include multiple servers. Additionally, in alternative embodiments, the enterprise server 30 and the authentication server 40 may be one server.

In the illustrated example, the computing device 20, the enterprise server 30, and the authentication server 40 communicate over a network 12, such as the Internet. In alternative embodiments, the computing device 20, the enterprise server 30, and the authentication server 40 may communicate over multiple networks. For example, the computing device 20 and the enterprise server 30 may be located in a local environment and communicate with each other over a local area network, and the authentication server 40 may be remote and communicate with the computing device 20 and the enterprise server 30 over the Internet.

A user 10 uses the system 100 to access enterprise resources. Enterprise resources may include profile information of the user including access rights to particular applications, databases, computing resources, and the like. In an example implementation, enterprise resources may include enterprise applications.

In the illustrated example, the enterprise server 30 hosts enterprise applications 32 (used for purposes of illustration of an example enterprise resource) which the user 10 can access on the computing device 20. Because the enterprise applications 32 may include sensitive or confidential information or may allow access to secure enterprise systems, specific authorization may be required for the user 10 to access the enterprise applications 32. For example, a first enterprise application 32A may allow access to enterprise financial information, so to prevent malicious actors from accessing the enterprise financial information, users 10 may need to be authorized to access the first enterprise application 32A.

As described further herein, the enterprise applications 32 may have different assurance levels for accessing the enterprise applications 32. In an example, the first enterprise application 32A has a high assurance level, requiring identity verification each time the first enterprise application 32A is accessed. For example, the first enterprise application 32A may allow access to security settings of the user 10, such as providing access to the identity service 42 to register authenticators or change a password of the user. A second enterprise application 32B has a medium assurance level, requiring a verified authenticator to access the second enterprise application 32B. For example, the second enterprise application 32B may be an application that accesses financial accounts of the enterprise. A third enterprise application 32C has a low assurance level, requiring any authenticator (i.e., either a verified or an unverified authenticator) to access the third enterprise application 32C. For example, the third enterprise application 32C may allow access to confidential enterprise information or an enterprise email account. A fourth enterprise application 32D has no assurance level, in that it may require credentials but no authenticator for multifactor authentication to access the fourth enterprise application 32D. For example, the fourth enterprise application 32D may allow access to a subscription news service. In alternative examples, different assurance levels may be used. Additionally, as described further herein, in some embodiments, the enterprise applications 32 have multiple assurance levels such that different assurance levels apply to different users—i.e., the enterprise application 32 may have a high assurance level for an untrusted user and a low assurance level for a trusted user.

The authentication server 40 authenticates the user 10 to verify that the user 10 is authorized to access the enterprise applications 32. In the illustrated embodiment, the authentication server 40 includes an identity service 42, an identity verification service 44, and an authentication database 46. The identity service 42 determines the level of authentication required for the user 10 based on the assurance level of the enterprise application 32 that the user 10 is accessing. Additionally, in some examples, the identity service 42 may also determine the level of authentication required for the user 10 based on an authorization level of the user 10. In embodiments, the authentication database 46 stores information regarding the assurance levels of the enterprise applications 32 and the authorization levels of users 10.

After determining the level of authentication required, the identity service 42 determines if the user 10 has an approved authenticator. Using the example described above, because the second enterprise application 32B has a medium assurance level, the user 10 is required to have a registered verified authenticator. If the user 10 does not have an approved authenticator, the identity service 42 may deny the user 10 access to the enterprise application 32. Alternatively, if the user 10 does not have an approved authenticator, the identity service 42 may require the user 10 to verify his identity with the identity verification service 44 to access the enterprise application 32.

Using the approved authenticator, the identity service 42 authenticates the user. In an example, the identity service 42 verifies credentials of the user 10 and performs multi-factor authentication, such as sending a one-time password to the user 10 for verification. In alternative embodiments, the identity service 42 may use third-party authenticators for multi-factor authentication. As described further herein, the user 10 may register authenticators with the identity service 42 to verify the authenticator by performing identity verification with the identity verification service 44 at the time of registering the authenticator. Similarly, the user 10 may register authenticators without verifying the authenticators (i.e., without performing identity verification at the time of registering). In further examples, the identity service 42 requires the user 10 to be authenticated by the identity verification service 44 each time the user 10 accesses an enterprise application 32.

The identity verification service 44 verifies the identities of users 10. In example embodiments, the identity verification service 44 compares information about the user 10 to information captured in an identification document (e.g., a user badge) to verify the identity of the user 10. In an example, the identity verification service 44 compares an image of the user 10 to an image on the identification document to determine if the images match. In some embodiments, the identity verification service 44 may additionally validate that the identification document is authentic. In examples, the identity verification service 44 may be performed using the Entrust Identity Verification as a Service (IDVaaS) solution provided by Entrust Corporation of Shakopee, Minnesota.

In some additional example embodiments, the identity verification service 44 may enable a user to store a secure object on the computing device 20 prior to attempting to initiate access to one or more enterprise applications and/or to access user profile or authenticator settings. Such a secure object may represent a result of identity verification, and may include relevant details indicating identity verification of the user. When identity verification is required (e.g., at the time of access of an enterprise application, or a time of registering an authenticator), the secure object may be provided by the computing device 20 to the identity verification service 44 for validation in place of presentation of the image of the user and the image of the identification document at that time. Such a system, which may be utilized herein, is described in U.S. patent application Ser. No. 19/042,698, filed on Jan. 31, 2025, and entitled “Distributable Secure Transaction Object,” the disclosure of which is hereby incorporated by reference in its entirety.

In implementations, the system 100 described above may have a variety of applications. For example, use of an identity verification service 44 may be configurable as a prerequisite to access enterprise applications as described above, but may also be required to enable access to other enterprise resources, such as to change a username or password of a user, to change or update methods, passwords, and/or authenticators used in multifactor authentication, to enable installation of software on enterprise networks, to change access privileges of a user or user group as to resources owned or controlled by the enterprise, and the like.

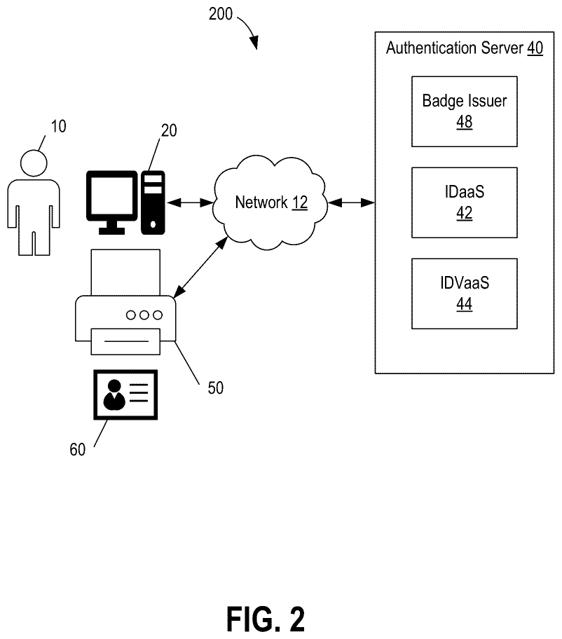

FIG. 2 illustrates an example identification document issuance system 200 that utilizes the identity verification service for additional user verification in a high security context where a physical credential is required, for example an access badge, or the like. In an example embodiment, the system 200 issues a user badge 60 that can be used during identity verification of a user 10. In the illustrated embodiment, the system 200 includes a computing device 20, an authentication server 40, and a printer 50. The computing device 20, the authentication server 40, and the printer 50 communicate over a network 12. In alternative embodiments, the computing device 20, the authentication server 40, and the printer 50 may communicate over multiple networks, such as a local area network and the Internet.

The user 10 uses the computing device 20 to access a badge issuer 48 on the authentication server 40. In an example, before the user 10 can access the badge issuer 48, an identity service 42 authenticates the user 10. For example, the user 10 may need to provide credentials to access the badge issuer 48. In alternative examples, an identity verification service 44 is used by the authentication server 40 to authenticate the user. For example, the user 10 may need to provide information from an identification document, such as a passport, to confirm the identity of the user 10. As noted previously, rather than presentation of an image of the user and identification document at the time of badge issuance, the user may store a secure object on the computing device, as described in U.S. patent application Ser. No. 19/042,698, which was incorporated by reference above.

The user 10 provides user information to the badge issuer 48, and the badge issuer 48 compiles the information to create a user badge 60. In an example, the user information includes an image of the user 10, a name, and an employee number. In alternative examples, additional or alternative information may be provided to the badge issuer 48 and included in the user badge 60. The badge issuer 48 generates the user badge 60 using the user information. In an embodiment, the badge issuer 48 creates a signed hash of the user information and includes a quick-response (QR) code embedding the signed hash on the user badge 60. In an example, the hash is signed with a private key of the authentication server 40 or a private key of a component of the authentication server 40, such as the badge issuer 48 or the identity verification service 44. The QR code can be used by an identity verification service 44 to authenticate the user badge 60. Accordingly, even if a malicious actor copies the user information on the user badge 60, the malicious actor cannot recreate the QR code without the private key used to sign the hash.

After the badge issuer 48 generates the user badge 60, the badge issuer 48 transmits the user badge 60 to a printer 50. The user 10 may then print a physical copy of the user badge 60 using the printer 50. The user 10 can then use the user badge 60 for identity verification.

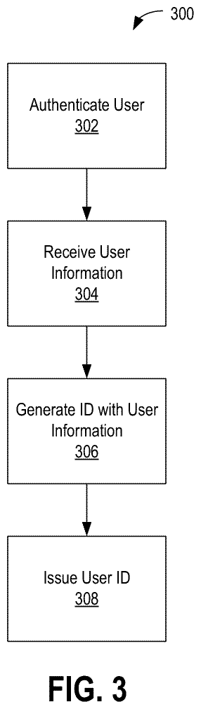

FIG. 3 illustrates a flowchart of an example method 300 for generating an identification document, such as a user badge, with identity verification. The method 300 includes operations 302, 304, 306, 308. In an example, the method 300 is performed by the identification document issuance system 200 described above in connection with FIG. 2.

In the example shown, the operation 302 includes authenticating a user. In an embodiment, the user is authenticated by receiving credentials of the user and verifying the credentials. In an alternative embodiment, multi-factor authentication is used to authenticate the user. In further embodiments, identity verification is used to authenticate the user. For example, the user may use a previously issued identification document, such as a passport, to verify the user's identity. In an embodiment, an identity service authenticates the user. An identity verification service may additionally or alternatively authenticate the user.

The operation 304 includes receiving user information. In an embodiment, the user information includes an image of the user, a name, and an employee number. In alternative embodiments, additional or alternative information may be received. In an embodiment, a badge issuer receives information input by a user at a computing device.

The operation 306 includes generating an identification document. The user information received in the operation 304 is compiled into the identification document. In an embodiment, a signed hash of the user information is generated and included in a QR code included on the identification document. In an example, the hash is signed by a private key such that a malicious actor cannot recreate the QR code without the private key, even if the malicious actor has all of the user information. In an embodiment, a badge issuer generates the identification document.

The operation 308 includes issuing the identification document. In an embodiment, a printer prints a physical copy of the identification document for the user. In an example, a badge issuer transmits the identification document to the printer.

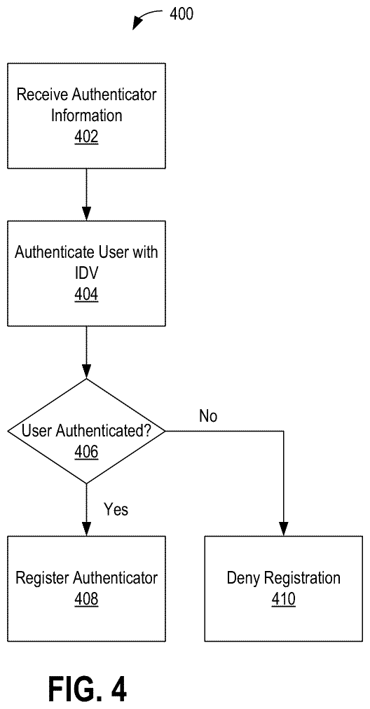

Turning now to FIG. 4, a flowchart of an example method 400 for registering an authenticator as a verified authenticator. The method 400 includes operations 402, 404, 406, 408, 410. In an embodiment, the method 400 is performed by the application access management system 100 described above in connection with FIG. 1.

The operation 402 includes receiving authenticator information. A user selects an authenticator that the user wishes to register as a verified authenticator. In an example, the user selects a third-party authenticator. In an alternative example, the user selects an authentication method provided by an identity service, such as one-time password delivery over SMS messages. In some embodiments, the authenticator is already registered, but the authenticator was not verified during the previous registration process. In an embodiment, an identity service receives the authenticator information.

The operation 404 includes authenticating the user with identity verification. As described further herein, the user uses an identification document, such as a user badge described above, to verify the identity of the user. In an embodiment, an identity verification service authenticates the user.

The operation 406 includes determining if the user was authenticated during the operation 404. If the user was authenticated, the method 400 proceeds to the operation 408 and the authenticator is registered as a verified authenticator. If the user was not authenticated, the method 400 proceeds to the operation 410, and registration of the authenticator is denied. In an embodiment, the operation 410 further includes issuing a warning that an unauthenticated user attempted to register an authenticator. For example, an alert may be transmitted to an administrator of an identity service.

In an embodiment, an identity service determines if the user was authenticated by an identity verification service and either registers the authenticator or denies the registration based on the result of the authentication.

In alternative embodiments, authenticator information is not received until the operation 408 in which the authenticator is registered. In such embodiments, the operation 402 may include receiving an indication that the user wishes to register an authenticator, but the indication does not specify the authenticator that the user wishes to register.

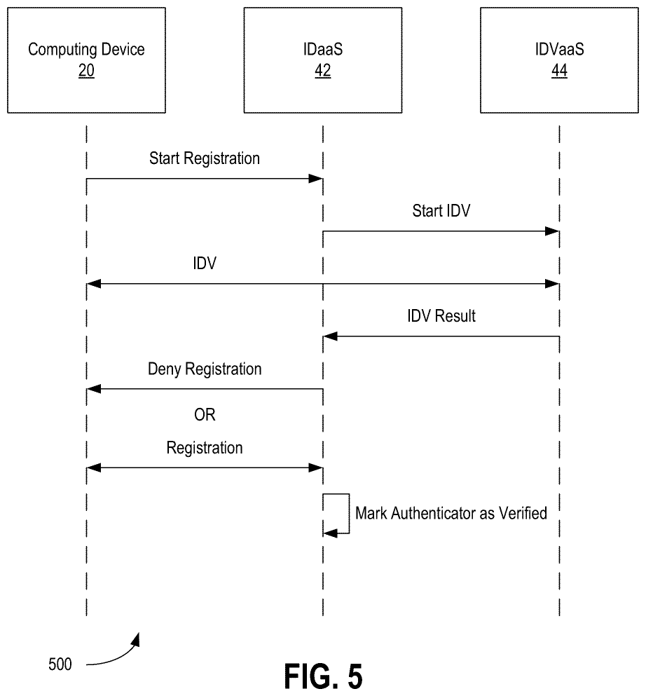

FIG. 5 is a message flow diagram 500 for registering an authenticator as a verified authenticator. In the illustrated embodiment, a computing device 20, an identity service 42, and an identity verification service 44 communicate to register the authenticator.

In the example as illustrated, computing device 20 initiates registration of the authenticator with the identity service 42. In an example, a user of the computing device 20 selects an authenticator to add as a verified authenticator. The verified authenticator may be a software program, such as a mobile application, configured to be registrable on a user's computing device and which provides a separate authentication request when multi-factor authentication is required. For example, such an authenticator may be implemented as a mobile application configured to receive push authentication messages or text (SMS) messages when multi-factor authentication is required. In an alternative example, the user of the computing device 20 provides an indication that he wishes to register an authenticator, but the authenticator is not specified. In response to starting the registration process, the identity service 42 starts identity verification with the identity verification service 44.

The identity verification service 44 cooperates with the computing device 20 to complete the identity verification. As described below, the identity verification service 44 confirms that the user of the computing device 20 matches an identification document, such as a user badge or government-issued user identification document (e.g., a driver's license, a passport, or the like). In an embodiment, the identity verification service additionally confirms that the identification document is authentic.

The identity verification service 44 returns the results of the identity verification process to the identity service 42. If the user is not authenticated by the identity verification process, the registration is denied. If the user is authenticated by the identity verification process, the identity service 42 cooperates with the computing device 20 to register the authenticator as a verified authenticator. In embodiments in which the authenticator is not selected by the user during the initialization of the registration process, the user may select an authenticator to register at this step. The identity service 42 marks the authenticator as a verified authenticator.

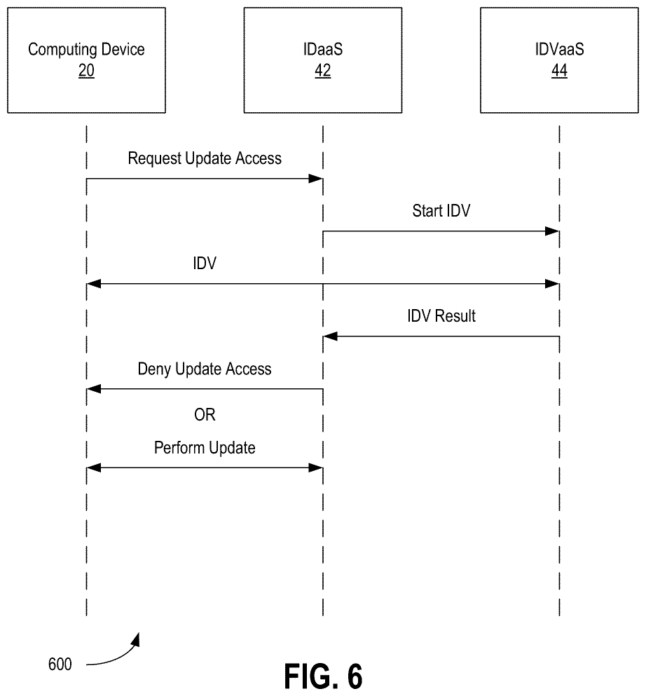

FIG. 6 illustrates a message flow diagram 600 for managing user security settings. For example, a user may access the security settings to add or remove verified authenticators. In an example, the user may access the security settings to change a credential, such as changing a password. In the illustrated embodiment, a computing device 20, an identity service 42, and an identity verification service 44 communicate to manage user security settings.

The computing device 20 requests update access from the identity service 42. In an example, the update access allows the user to modify security settings, such as credentials associated with a user account and registered authenticators. In response to receiving the request for update access, the identity service 42 starts identity verification with the identity verification service 44. In an embodiment, identity verification is initiated because accessing the identity service 42 to modify security settings is treated as a high assurance application which requires identity verification each time the identity service 42 is accessed for this purpose.

The identity verification service 44 cooperates with the computing device 20 to complete the identity verification, and an identity verification result is transmitted from the identity verification service 44 to the identity service 42. If the user is not authenticated by the identity verification process, the identity service 42 denies the user update access. If the user is authenticated by the identity verification process, the user is granted update access and can update security settings with the identity service 42.

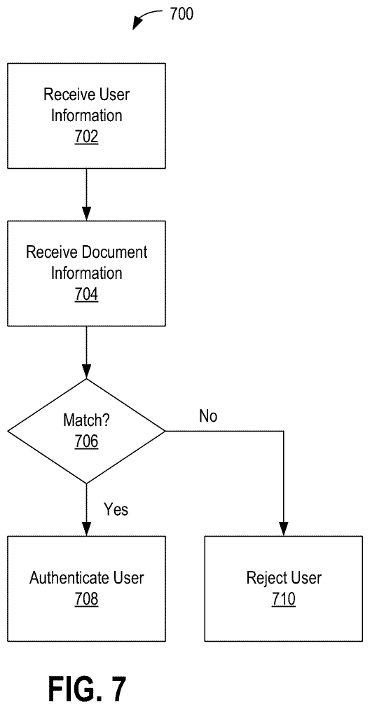

Turning now to FIG. 7, a flowchart of an example method 700 for performing identity verification of a user is provided. The method 700 includes operations 702, 704, 706, 708, 710. In an embodiment, the method 700 is performed by the identity verification service 44 described above in connection with FIG. 1.

The operation 702 includes receiving user information. In an example, the user information includes an image of the user. In alternative example, additional or alternative information may be included in the user information. In an embodiment, an identity verification service receives the user information from a computing device.

The operation 704 includes receiving information associated with an identification document. In an example, the identification document is a user badge. In alternative example, any type of identification document can be used, including passports, drivers' licenses, and the like. In embodiments, the information associated with the identification document includes an image of the user from the identification document. In alternative embodiments, additional or alternative information associated with the identification document is received.

In an embodiment, the information associated with the identification document is received by capturing an image of the identification document and extracting the information from the image of the identification document. In this embodiment, a computing device may capture the image of the identification document and extract the information to send to an identity verification service. Alternatively, the computing device may transmit the image of the identification document to the identity verification service, and the identity verification service extracts the information. In an alternative embodiment, the information is received by scanning an integrated circuit embedded in the identification document or a machine-readable optical image (e.g., a QR code) printed on the identification document. In such an embodiment, a computing device may scan the integrated circuit or machine-readable optical image and transmit the information to an identity verification service.

The operation 706 includes determining whether the user information received during the operation 702 matches the information associated with the identification document received during the operation 704. In an example, an image of the user received during the operation 702 is compared to an image of the user on the identification document received during the operation 704. In an embodiment, an identity verification service compares the user information to the information associated with the identification document.

If the information matches, the method 700 proceeds to the operation 708, and the user is authenticated. If the information does not match, the method 700 proceeds to the operation 710, and the user is not authenticated. In an embodiment, an identity verification service authenticates or rejects the user.

In alternative embodiments, the method 700 additionally includes authenticating the identification document. In an example, the information associated with the identification document received during the operation 704 includes a signed hash of the information. In this example, the operation 706 includes authenticating the identification document may confirming that the signed hash is authentic. For example, a private key may be used to authenticate the signed hash.

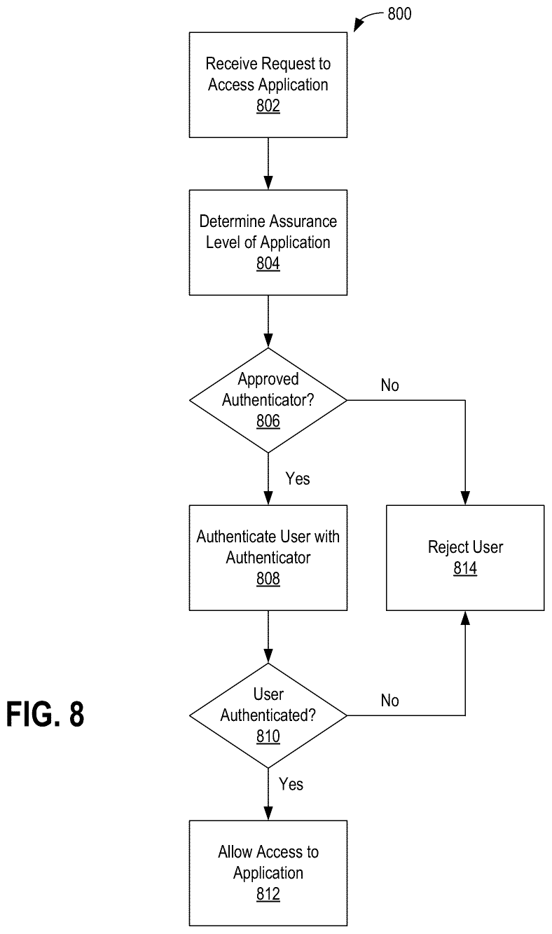

Turning to FIG. 8, a flowchart of an example method 800 for managing access to applications is shown. The method 800 includes operations 802, 804, 806, 808, 810, 812, 814. In an embodiment, the operation 800 is performed by the application access management system 100 described above in connection with FIG. 1. While the illustrated method 800 describes managing access to applications, the method 800 may similarly be performed to manage access to other secure resources.

The operation 802 includes receiving a request to access an application. In an example, the application is an enterprise application. In an embodiment, an identity service receives the request from a computing device on which a user is working.

The operation 804 includes determining an assurance level of the application. In an embodiment, applications can have one of the following assurance levels: no assurance level, which requires credentials (i.e., a username and password) to access the application; a low assurance level, which requires an authenticator to access the application; a medium assurance level, which requires a verified authenticator (i.e., an authenticator registered by a user who has undergone identity verification, as described above) to access the application; and a high assurance level, which requires identity verification each time the application is accessed.

In alternative embodiments, an application may have multiple assurance levels, where different users have different requirements to access the application. For example, the application may have a medium assurance level for users with a high authorization level, but the application may have a high assurance level for users with a medium or lower authorization level. In an embodiment, users have a single authorization level that applies to all applications. In an alternative embodiment, users may have authorization levels specific to applications. In an example, the application may be a financial application to access enterprise financial accounts. In this example, it is less likely that fraud is occurring when a chief financial officer of the enterprise is accessing the financial application than when a lower-level employee is accessing the application. Accordingly, the chief financial officer may have a higher authorization level for the financial application than the lower-level employee. In another example, the users' authorization levels for applications may depend on the users' locations. For example, if an application allows access to information for a branch of the enterprise in Kansas City, MO, an employee at that branch may have a higher authorization level for the application than an employee at a branch of the enterprise in Orlando, FL.

In embodiments in which applications have multiple assurance levels, and a user's authorization level determines which assurance level applies, the operation 804 may additionally include determining the authorization level of the user.

In embodiments, an identity service determines the assurance level of the application. For example, the identity service may reference an authorization database to determine the assurance level of the application. Similarly, the identity service may determine an authorization level of a user.

The operation 806 includes determining if the user has an approved authenticator based on the assurance level of the application. For example, as described above, if the application has a medium assurance level, the user must have a registered verified authenticator to access the application. Similarly, if the application has a low assurance level, the user must have a registered authenticator, regardless of whether the authenticator is verified. In an embodiment, an identity service determines if the user has an approved authenticator.

If the user does not have an approved authenticator, the method 800 proceeds to the operation 814, and the user is rejected from accessing the application. Alternatively, if the user does not have an approved authenticator, the method may proceed to the operation 808 to authenticate the user, and an identity verification service acts as the authenticator to confirm the identity of the user.

If the user has an approved authenticator, the method 800 proceeds to the operation 808, and the user is authenticated with the approved authenticator. In an embodiment, the identity service is the authenticator. For example, the identity service may issue a one-time password to the user over an SMS message. In alternative embodiments, a third-party authenticator is used to authenticate the user. In an example in which the application has a high assurance level, the authenticator may include an identity verification service to perform identity verification of the user.

In some examples, the user may have multiple approved authenticators. In such an example, one of the approved authenticators is selected to authenticate the user. For example, the earliest registered approved authenticator is may be used. In another example, the user may set a hierarchy of authenticators, and the approved authenticator that is highest in the hierarchy is used. In a further example, the user may assign applications to the authenticators, and the authenticator associated with the application that the user is accessing is used.

The operation 810 includes determining if the user was authenticated. If the user is authenticated, the method 800 proceeds to the operation 812, and the user is allowed access to the application. If the user is not authenticated, the method 800 proceeds to the operation 814, and the user is rejected. In an embodiment, an identity service either allows the user to access the application or rejects the user.

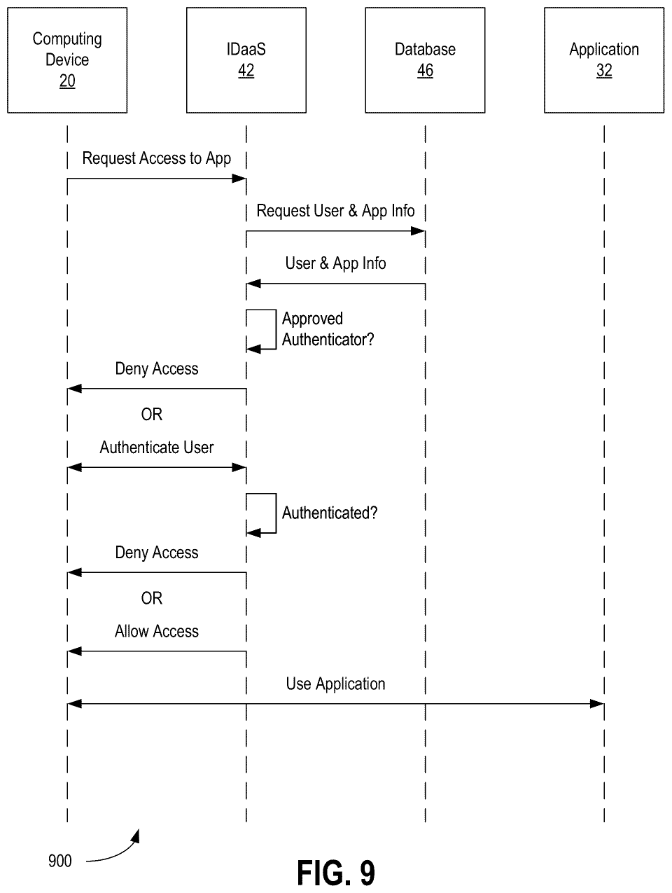

FIG. 9 illustrates an example message flow diagram 900 for managing access to applications. In the illustrated embodiment, a computing device 20, an identity service 42, and a database 46 cooperate to manage access to an application 32. While the illustrated message flow diagram 900 describes managing access to applications, access to other secure resources may be managed similarly.

The identity service 42 receives a request to access the application 32 from the computing device 20. The identity service 42 requests information about the application 32 from the database 46, such as an assurance level of the application. The identity service 42 also requests information about a user from the database 46, such as authenticators associated with the user. In some embodiments, the information about the user may additionally include an authorization level of the user. The database 46 returns the requested information to the identity service 42.

Using the application assurance level and the information about authenticators associated with the user, the identity service 42 determines if the user has an approved authenticator to access the application 32. For example, if the application 32 has a medium assurance level, the user requires a verified authenticator to access the application 32. If the user does not have an approved authenticator, the identity service 42 denies the user access to the application 32. In alternative examples, if the user does not have an approved authenticator, the identity service 42 requires the user to perform identity verification with an identity verification service.

If the user has an approved authenticator, the identity service 42 works with the computing device 20 to authenticate the user. In an example, the identity service 42 sends a one-time password to the computing device via an SMS message. In alternative examples, the identity service 42 may cooperate with a third-party authenticator to authenticate the user. In further examples, such as when the application 32 has a high assurance level, the identity service 42 may cooperate with an identity verification service to perform identity verification of the user.

The identity service 42 determines if the user is authenticated. If the user is not authenticated, the identity service 42 denies the user access to the application 32. If the user is authenticated, the identity service 42 allows the user access to the application 32. The computing device 20 connects to the application 32 for the user to use the application 32.

It is noted that the methods and flows of FIGS. 3-8 may vary in different embodiments. For example, depending on whether a secure transaction object is able to be created, timing of using an identity verification service may vary. Other orders of operations may be utilized as well, in accordance with the present disclosure.

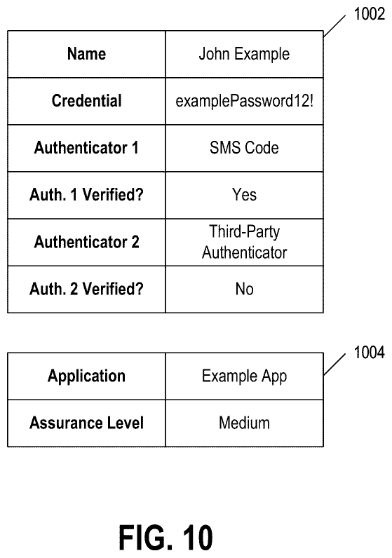

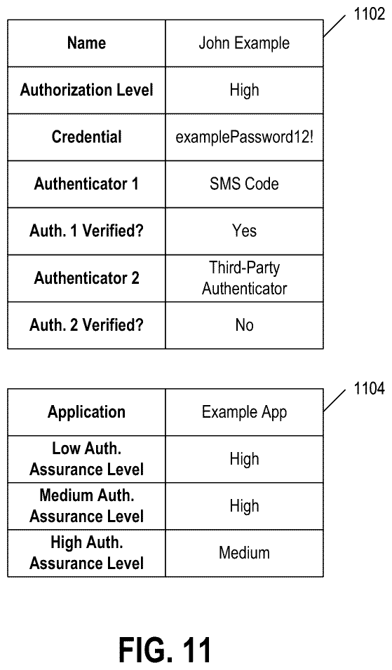

FIGS. 10 and 11 illustrate example user records 1002, 1102 storing information associated with a user and application records 1004, 1104 storing information associated with an application. FIG. 10 illustrates an example in which the application has a single assurance level that applies to all users.

In the illustrated example, the user record 1002 includes a name of the user, a credential for the user, such as a password, and registered authenticators. In the illustrated example, the user record 1002 includes two registered authenticators: one-time passwords delivered over SMS and a third-party authenticator. In this example, the first authenticator is a verified authenticator (i.e., the user performed identity verification at the time of registering the authenticator), and the second authenticator is an unverified authenticator.

In this example, as indicated in the application record 1004, the application has a medium assurance level. Accordingly, a registered verified authenticator is required to access the application. Because the first authenticator is verified, the user can use the first authenticator to authenticate the user and access the application. However, because the second authenticator is not verified, the user cannot use the second authenticator to access the application.

FIG. 11 illustrates a similar example but includes user authorization levels and multiple assurance levels for the application. In the illustrated example, as shown in the application record 1104, the assurance level of the application depends on the authorization level of the user. In this example, if the user has a low or a medium authorization level, the application has a high assurance level, so a user with these authorization levels would need to perform identity verification each time the user accessed the application. If a user has a high authorization level, the application has a medium assurance level. In the illustrated example, as shown in the user record 1102, the user has a high authorization level. Accordingly, the application has a medium assurance level for the user, and the user can use the first authenticator to access the application, as described above.

Although not shown for ease of illustration, information stored in the user records 1002, 1102 and the application records 1004, 1104 shown in FIGS. 10 and 11 may be encrypted or otherwise protected.

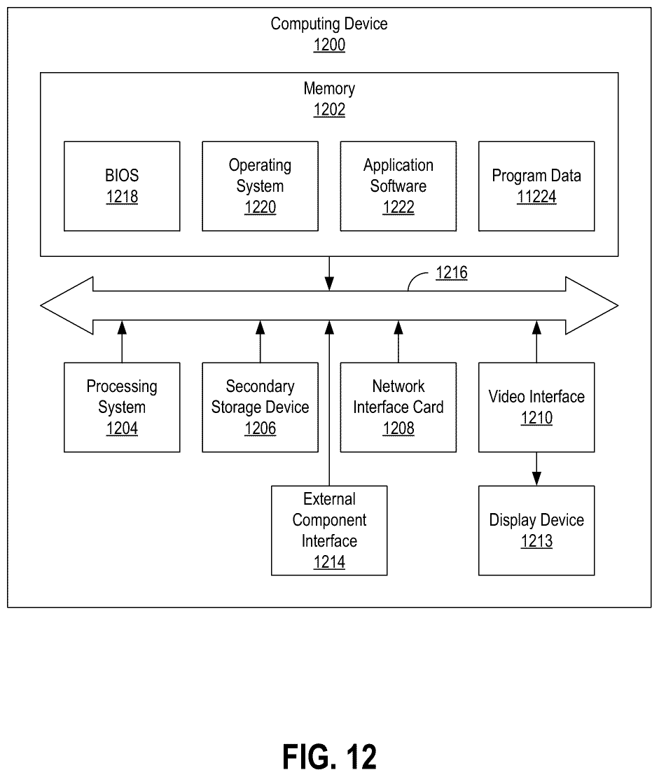

FIG. 12 illustrates an example computing device 1200 on which aspects of the present disclosure may be implemented. The computing device 1200 can be used, for example, to implement computing devices such as the computing device 20, the enterprise server 30, the authentication server 40, or any other computing device useable as described above in connection with FIG. 1.

In the example of FIG. 12, the computing device 1200 includes a memory 1202, a processing system 1204, a secondary storage device 1206, a network interface card 1208, a video interface 1210, a display unit 1213, an external component interface 1214, and a communication medium 1216. The memory 1202 includes one or more computer storage media capable of storing data and/or instructions. In different embodiments, the memory 1202 is implemented in different ways. For example, the memory 1202 can be implemented using various types of computer storage media, and generally includes at least some tangible media. In some embodiments, the memory 1202 is implemented using entirely non-transitory media.

The processing system 1204 includes one or more processing units, or programmable circuits. A processing unit is a physical device or article of manufacture comprising one or more integrated circuits that selectively execute software instructions. In various embodiments, the processing system 1204 is implemented in various ways. For example, the processing system 1204 can be implemented as one or more physical or logical processing cores. In another example, the processing system 1204 can include one or more separate microprocessors. In yet another example embodiment, the processing system 1204 can include an application-specific integrated circuit (ASIC) that provides specific functionality. In yet another example, the processing system 1204 provides specific functionality by using an ASIC and by executing computer-executable instructions.

The secondary storage device 1206 includes one or more computer storage media. The secondary storage device 1206 stores data and software instructions not directly accessible by the processing system 1204. In other words, the processing system 1204 performs an I/O operation to retrieve data and/or software instructions from the secondary storage device 1206. In various embodiments, the secondary storage device 1206 includes various types of computer storage media. For example, the secondary storage device 1206 can include one or more magnetic disks, magnetic tape drives, optical discs, solid-state memory devices, and/or other types of tangible computer storage media.

The network interface card 1208 enables the computing device 1200 to send data to and receive data from a communication network. In different embodiments, the network interface card 1208 is implemented in different ways. For example, the network interface card 1208 can be implemented as an Ethernet interface, a fiber optic network interface, a wireless network interface (e.g., WiFi, WiMax, Bluetooth, etc.), or another type of network interface.

In optional embodiments where included in the computing device 1200, the video interface 1210 enables the computing device 1200 to output video information to the display unit 1213. The display unit 1213 can be various types of devices for displaying video information, such as an LCD display panel, a plasma screen display panel, a touch-sensitive display panel, an LED or OLED screen, a cathode-ray tube display, or a projector. The video interface 1210 can communicate with the display unit 1213 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 1214 enables the computing device 1200 to communicate with external devices. For example, the external component interface 1214 can be a USB interface and/or another type of interface that enables the computing device 1200 to communicate with external devices or peripheral devices integrated within the same housing (e.g., in the case of mobile devices). In various embodiments, the external component interface 1214 enables the computing device 1200 to communicate with various external components, such as external storage devices, input devices, speakers, modems, media player docks, other computing devices, scanners, digital cameras, and fingerprint readers.

The communication medium 1216 facilitates communication among the hardware components of the computing device 1200. The communication medium 1216 facilitates communication among the memory 1202, the processing system 1204, the secondary storage device 1206, the network interface card 1208, the video interface 1210, and the external component interface 1214. The communication medium 1216 can be implemented in various ways. For example, the communication medium 1216 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 1202 stores various types of data and/or software instructions. The memory 1202 stores a Basic Input/Output System (BIOS) 1218 and an operating system 1220. The BIOS 1218 includes a set of computer-executable instructions that, when executed by the processing system 1204, cause the computing device 1200 to boot up. The operating system 1220 includes a set of computer-executable instructions that, when executed by the processing system 1204, cause the computing device 1200 to provide an operating system that coordinates the activities and sharing of resources of the computing device 1200. Furthermore, the memory 1202 stores application software 1222. The application software 1222 includes computer-executable instructions, that when executed by the processing system 1204, cause the computing device 1200 to provide one or more applications. The memory 1202 also stores program data 1224. The program data 1224 is data used by programs that execute on the computing device 1200.

Although particular features are discussed herein as included within an electronic computing device 1200, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include various types of dynamic random access memory (DRAM), solid state memory, read-only memory (ROM), electrically-erasable programmable ROM, magnetic disks (e.g., hard disks, floppy disks, etc.), and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is noted that, in some embodiments of the computing device 1200 of FIG. 12, the computer-readable instructions are stored on devices that include non-transitory media. In particular embodiments, the computer-readable instructions are stored on entirely non-transitory media.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. A method for managing access to enterprise resources, the method comprising:
receiving a request from a user to access an enterprise resource;
determining an assurance level of the enterprise resource;
determining, based on the assurance level of the enterprise resource, whether the user has an approved authenticator to access the enterprise resource and whether to allow access to the enterprise resource based, at least in part, on whether the user has an approved authenticator,
wherein the user is allowed to perform authentication using the approved authenticator if the user has the approved authenticator to access the enterprise resource, and the user is denied access to the enterprise resource if the user does not have the approved authenticator.

2. The method of claim 1, further comprising:
if the user is authenticated using the approved authenticator:
granting the user access to the enterprise resource; or
if the user is not authenticated using the approved authenticator:
denying the user access to the enterprise resource.

3. The method of claim 1, wherein the assurance level is high, and the approved authenticator includes identity verification by an identity verification service.

4. The method of claim 1, wherein the assurance level is medium, and the approved authenticator is a registered verified authenticator.

5. The method of claim 4, further comprising:
receiving authenticator information associated with an authenticator;
authenticating the user using identity verification; and
registering the authenticator as the registered verified authenticator.

6. The method of claim 5, wherein authenticating the user using identity verification includes:
receiving user information associated with the user;
receiving document information associated with an identification document of the user;
comparing the user information to the document information; and
if the user information matches the document information:
authenticating the user.

7. The method of claim 6, wherein the document information includes a name of the user, an employee number of the user, an image of the user, and a signed hash of the name, the employee number, and the image.

8. The method of claim 7, further comprising:
validating the identification document based on the signed hash.

9. The method of claim 1, wherein the assurance level is low, and the approved authenticator is a registered authenticator.

10. The method of claim 1, wherein the enterprise resource provides access to register an authenticator.

11. The method of claim 1, wherein the enterprise resource provides access to change a password associated with the user.

12. The method of claim 1, wherein determining the assurance level of the enterprise resource includes:
determining an authorization level of the user; and
selecting the assurance level from a plurality of assigned assurance levels based on the authorization level of the user.

13. A system for managing access to applications, the system comprising:
one or more processors; and
one or more computer-readable storage devices storing data instructions that, when executed by the one or more processors, cause the system to:
receive a request from a user to access an application;
determine an assurance level of the application;
determine, based on the assurance level of the application, whether the user has an approved authenticator to access the application; and
if the user has the approved authenticator to access the application:
authenticate the user using the approved authenticator; or
if the user does not have the approved authenticator to access the application:
deny the user access to the application.

14. The system of claim 13, wherein the assurance level is high, and the approved authenticator includes identity verification by an identity verification service.

15. The system of claim 13, wherein the assurance level is medium, and the approved authenticator is a registered verified authenticator.

16. The system of claim 15, wherein the instructions, when executed by the one or more processors, further cause the system to:
receive authenticator information associated with an authenticator;
authenticate the user using identity verification; and
register the authenticator as the registered verified authenticator.

17. The system of claim 13, wherein the assurance level is low, and the approved authenticator is a registered authenticator.

18. A method for managing user security settings, the method comprising:
receiving a request from a user to modify security settings;
authenticating the user using identity verification; and
based on whether the user is authenticated, determining whether to enable user modification of the security settings or denying the user access to the security settings.

19. The method of claim 18, wherein the security settings include registration of authenticators.

20. The method of claim 18, wherein the security settings include changing a password.
